(19) United States
(12) Patent Application Publication
(10) Pub. No.: US 2011/0001016 A1
(43) Pub. Date: Jan. 6, 2011

(54) Telescoping and sweeping wing that is reconfigurable during flight

(76) Inventors: Robert Stewart Skillen, Bakersville, NC (US); Raymond Charles Jones, Leesburg, VA (US); Ross Michael Jones, Rileyville, VA (US)

Correspondence Address: Raymond C. Jones, 43787 Bent Creek Terrace, Leesburg, VA, 20176, US

(21) Appl. No.: 12/314,534

(22) Filed: Dec. 12, 2008

Related U.S. Application Data
(60) Provisional application No. 61/006,082, filed on Dec. 18, 2007.
(60) Provisional application No. 61/136,263, filed on Aug. 22, 2008.

(51) Int. Cl. B64C 3/54; B64D 37/04

(52) U.S. Cl. 244/218

(57) ABSTRACT

An aircraft wing includes a stationary root section and a telescoping end section slideable in the span wise direction, where the loads for the root and extendable end sections are carried predominately by the airfoil composite skins, rather than a framework of spars and ribs as in conventional aircraft wings. In a single-telescoping configuration the telescoping end section slides within the root section as it extends and retracts during flight, and in another, the telescoping end section slides over the root section as it extends and retracts during flight. The aircraft wing can also include a second telescoping distal end section, and can sweep back during flight, while the end sections or distal end sections are extended or retracted.

### RELATED APPLICATIONS

This application claims priority to U.S. patent application Ser. No. 61/006,082, filed Dec. 18, 2007, and U.S. patent application Ser. No. 61/136,263, filed Aug. 22, 2008, the entire contents of which are hereby incorporated herein by reference in their entirety.

### BACKGROUND OF THE INVENTION

1. Field of the Invention

The present invention relates generally to aircraft wings for manned and unmanned air vehicles, and more particularly to an aircraft wing with a stationary root section and at least one telescoping end section slideable relative to the root section, which can be reconfigured (extended or retracted) during flight. The aircraft wing can also sweep back during flight, while the telescoping end sections are extended or retracted.

2. Description of the Related Art

Aircraft are employed in a variety of roles, such as cargo and passenger carrying, reconnaissance, surveillance, or for delivering a payload in the form of munitions or missiles on a target.

Traditionally, aircraft are optimized for specific roles or missions. For instance, a surveillance aircraft is designed to fly slower, at higher altitudes and with greater endurance. On the other hand, a “strike” aircraft will usually be designed for relatively high-speed flight at lower altitudes, so as to minimize vulnerability of the aircraft to anti-aircraft measures. This diversity of design therefore requires engineering tradeoffs or compromises between conflicting demands for payload, speed, altitude, and endurance.

In order to expand the mission capabilities of a particular aircraft platform, some of skill in the art have proposed a concept employing a common fuselage with different, interchangeable wing and payload options to optimize the airframe for a particular mission.

For example, before an aircraft is launched, one could choose a long aspect ratio “sailplane-type” wing for high altitude surveillance missions and attach it to the airframe. By contrast, for high-speed reconnaissance or weapons delivery missions, a lower aspect ratio “fighter-type” wing configuration would be chosen and attached to the airframe prior to launch.

The need for two different interchangeable wings, however, has major drawbacks, namely flexibility and reaction time. With special regard for the military environment where the battlespace is constantly changing, in many cases the military force does not have the luxury of time to fly back and reconfigure the aircraft on the ground before engaging in a second mission. Nor does such an interchangeable wing concept allow the military to address “targets of opportunity” that arise during flight while the airborne asset is configured for a different mission.

Rather than using interchangeable wings, others have tried to improve on conventional spar and rib wing designs in order to provide an extendable wing structure. Since the load for these structures is carried by the internal spars and ribs, these designs must include multiple spars, spar extensions, guide rollers, guide bars and the like to ensure the load is accounted for during extension and retraction of the wing end.

Such additional internal structures, however, add weight, manufacturing complexity, repair complexity and cost to the aircraft program, all of which are problematic for successful aircraft operations and maintenance.

### SUMMARY OF THE INVENTION

It is an object of the present invention, therefore, to provide an aircraft wing that is sufficiently versatile to encourage and facilitate wider use of dual-mission or multi-mission aircraft, by providing a wing structure that is extendable/retractable and sweepable in flight, but is relatively simple to manufacture and maintain, and does not contain an abundance of complex internal structure.

Accordingly, the present invention provides an aircraft wing that includes a stationary root section and a telescoping end section (or sections) slideable in the span wise direction. The loads for the root and telescoping sections are carried predominately by the airfoil composite skins, rather than a framework of spars and ribs as in conventional aircraft wings. In a single-telescoping configuration the extendable section slides within the root section, and in another, the extendable wing slides over the root section as it extends and retracts during a flight regime. In another double-telescoping configuration, an additional telescoping distal end section may be incorporated, and is slideable relative to the telescoping end section. In still another embodiment, the wing may sweep back and forth during flight, while the telescoping end sections and/or telescoping distal end sections are extended or retracted.

With such inventive arrangements, an aircraft could be rapidly reconfigured in flight, and is able to perform multiple missions with little or no performance degradation. For example, FIG. 1 illustrates a hypothetical, but very realistic dual-mission scenario. In FIG. 1, an UCAV (unmanned combat air vehicle) takes off with its spanwise-extended wing providing a smooth, low speed take-off profile. During the high altitude surveillance mission, the telescoping wing ends remain extended, providing sufficient lift at lower loitering speeds for persistent surveillance. Upon target acquisition, the telescoping section of the wing is retracted, decreasing the wing's aspect ratio and area, while increasing the wing loading. The UCAV increases its speed as it dives to approach the “hot area”, either for reconnaissance or to drop/shoot a weapon. After the weapon is delivered, the UCAV exits the target area as quickly as possible, and then when back at altitude, extends its wing ends once again for additional surveillance/loitering missions.

The aircraft wing of the invention can be used in both manned and unmanned flight vehicles. Fuel can be stored in either the root section or the telescoping section. Those configurations and the slideable interaction are discussed further below.

Regardless of how the aircraft wing is configured, the aircraft itself will also preferably comprise other conventional aircraft features, such as a tail fin, movable control surfaces (which may be integral with the wings) and a fuselage.

While the embodiment shown in the drawings depicts a main wing, the invention may be utilized with any lifting surface or control surface regardless of the lift orientation, for example, a horizontal stabilizer or vertical stabilizer. The aircraft wing of the present invention may also be used on a missile-type structure.

### BRIEF DESCRIPTION OF THE DRAWINGS

The above objects and other advantages of the present invention will become more apparent by describing in detail the preferred embodiments thereof with reference to the attached drawings in which:

FIG. 1 is a schematic illustration of dual-mission performance scenario achievable by employing the aircraft wing of the invention;

FIG. 2A is a perspective view of the invention where the telescoping end section is retracted relative to the root section;

FIG. 2B is a perspective view of the invention where the telescoping end section is extended relative to the root section;

FIG. 3A is a plan view of a jackscrew employed to move the telescoping end section relative to the root section, where the telescoping end section is retracted in the root section;

FIG. 3B is a plan view of a jackscrew employed to move the telescoping end section relative to the root section, where the telescoping end section is extended relative to the root section;

FIG. 4A is a perspective view of the jackscrew rod's interaction with a thrust bracket/bearing in the telescoping end section;

FIG. 4B is a detailed perspective view of the thrust bracket/bearing of FIG. 4A;

FIG. 5 is a detailed perspective view of the center gear section of the exemplary jackscrew rod;

FIG. 6A is a perspective view of the scissor gear embodiment in the fully retracted position;

FIG. 6B is a perspective view of the scissor gear embodiment in the partially extended position;

FIG. 6C is a perspective view of the scissor gear embodiment in the fully extended position;

FIG. 7A is a plan view of a double-telescoping embodiment of the present invention, with the telescoping end section fully retracted, and the telescoping distal end section fully retracted;

FIG. 7B is a plan view of a double-telescoping embodiment of the present invention, with the telescoping end section partially extended, and the telescoping distal end section fully retracted;

FIG. 7C is a plan view of a double-telescoping embodiment of the present invention, with the telescoping end section fully extended, and the telescoping distal end section fully retracted;

FIG. 7D is a plan view of a double-telescoping embodiment of the present invention, with the telescoping end section fully extended, and the telescoping distal end section partially extended;

FIG. 7E is a plan view of a double-telescoping embodiment of the present invention, with the telescoping end section fully extended, and the telescoping distal end section fully extended;

FIG. 8A is a perspective view of a telescoping-sweeping embodiment of the present invention, with the wings in a conventional spanwise configuration;

FIG. 8B is a perspective view of a telescoping-sweeping embodiment of the present invention, with the wings partially swept back;

FIG. 8C is a perspective view of a telescoping-sweeping embodiment of the present invention, with the wings fully swept back;

FIG. 9A detailed perspective view of a telescoping-sweeping embodiment of the present invention employing a guide means, with the wings in a conventional spanwise configuration;

FIG. 9B is a detailed perspective view of a telescoping-sweeping embodiment of the present invention employing a guide means, with the wings partially swept back;

FIG. 9C is a detailed perspective view of a telescoping-sweeping embodiment of the present invention employing a guide means, with the wings fully swept back;

FIG. 10 is a perspective view of a telescoping fuel linkage connected to the telescoping end section of the present invention;

FIG. 11A is a perspective view of a telescoping-sweeping embodiment of the present invention employing an alternate guide means, with the wings in a conventional spanwise configuration;

FIG. 11B is a cut-away perspective view of the telescoping-sweeping embodiment of FIG. 11A;

FIG. 11C is a perspective view of a telescoping-sweeping embodiment of the present invention employing an alternate guide means, with the wings partially swept back;

FIG. 11D is a cut-away perspective view of the telescoping-sweeping embodiment of FIG. 11C;

FIG. 11E is a perspective view of a telescoping-sweeping embodiment of the present invention employing an alternate guide means, with the wings fully swept back; and

FIG. 11F is a cut-away perspective view of the telescoping-sweeping embodiment of FIG. 11E.

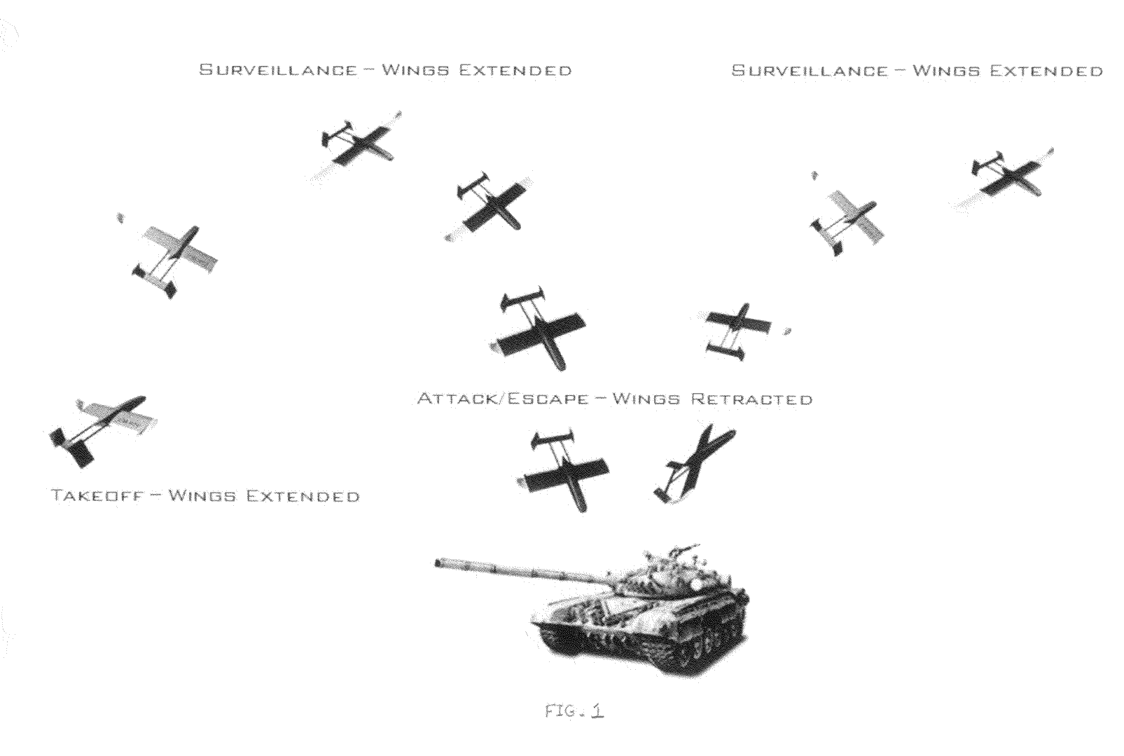

### DESCRIPTION OF PREFERRED EMBODIMENTS

The present invention will now be described more fully with reference to the accompanying drawings, in which preferred embodiments of the invention are shown. The invention may, however, be embodied in many different forms and should not be construed as being limited to the embodiments set forth herein; rather, these embodiments are provided so that this disclosure will be thorough and complete, and will fully convey the concept of the invention to those skilled in the art.

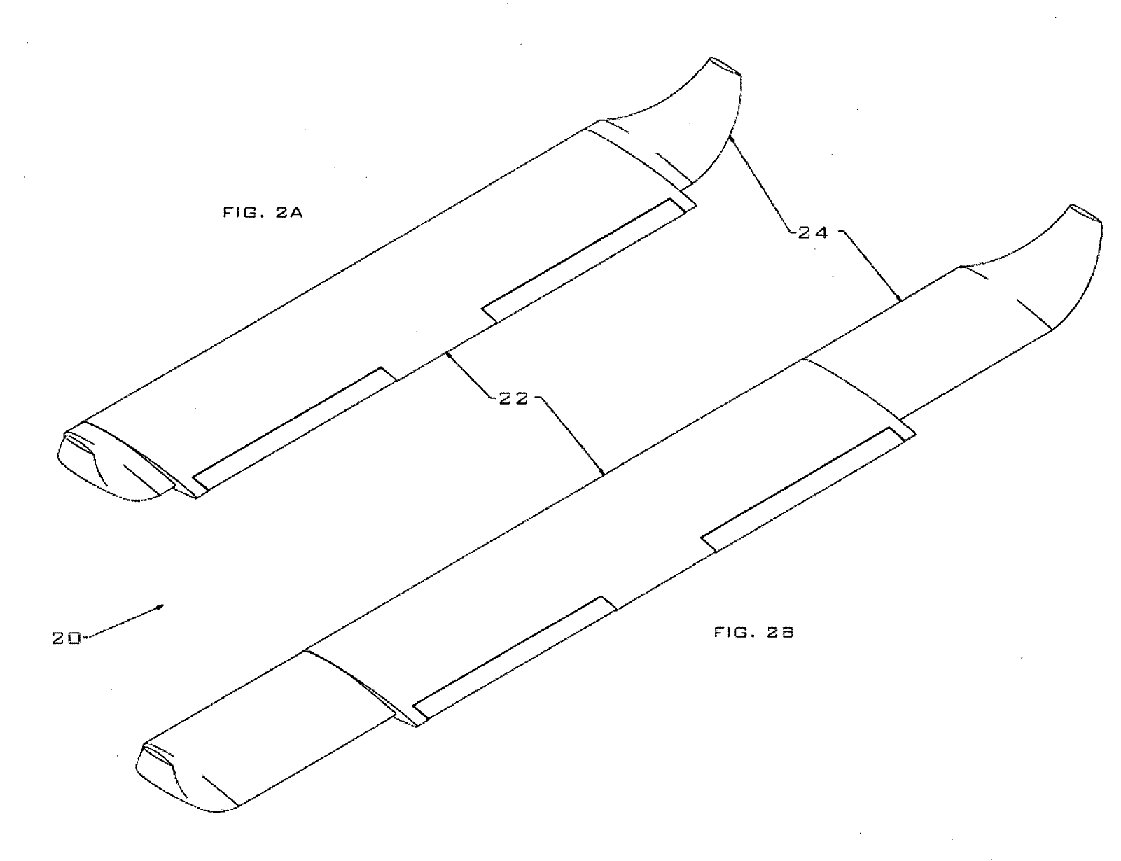

FIGS. 2A and 2B show an aircraft wing 20 in accordance with the invention, comprising an airfoil shaped root section 22 and an airfoil shaped telescoping end section 24. It is apparent that in FIG. 2A, the telescoping end 24 is retracted within the root section 22, and in FIG. 2B, the telescoping end 24 is extended from the root section 22. While the telescoping end 24 slides or moves back and forth within the root section 22 as shown in FIGS. 2A and 2B, one of skill in the art would understand that the invention encompasses other embodiments where the telescoping end 24 slides over the root section 22.

The aircraft wing can be reconfigured in flight by extending and retracting the telescoping end 24 relative to the root section 22, rendering the aircraft more versatile and improving its mission capabilities when compared with conventional aircraft.

The root section 22 and telescoping end 24 are composed of high strength composite materials, for example, carbon fibers in the proper orientation and ply lay-up combined with the correct core material and geometry. Other fiber types, for example, E-glass and S-glass may be employed singularly or in combination with the carbon fiber, depending on the load characteristics of the aircraft. Similarly, other existing or new fiber types may be employed as they are commercialized, depending on the load characteristics experienced in flight.

By employing high strength composite materials, the invention is able to utilize a hollow “monocoque” structure, eliminating the conventional spars and ribs required for structural support. The loads in monocoque structures are carried on the outside (the airfoil's composite skins) like the exoskeleton of an ant, leaving the inside of the wing completely hollow, which allows the telescoping end section 24 to move in and out of the root section 22.

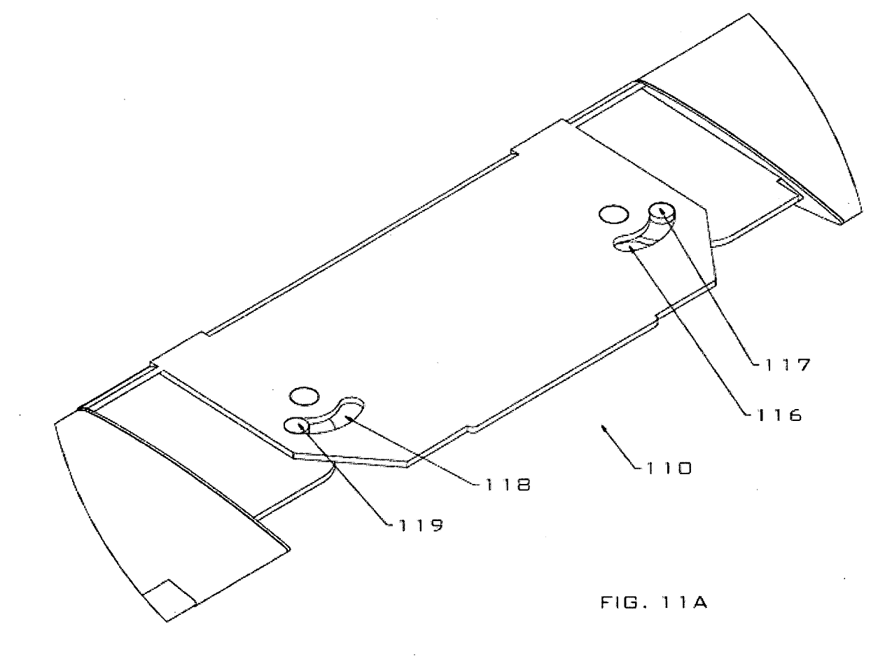

Fuel tanks, fuel feed systems, and conventional flight control linkages can still be accommodated in wing 20 of the invention. For example, fuel tanks or fuel bladders may reside in the telescoping portion 24, with a flexible fuel hose system, or telescoping fuel system 25 as shown in FIG. 10, attached thereto to accommodate the travel of the telescoping end section 24.

In another embodiment, the fuel tanks/bladders could be housed along the innermost portion of root section 22 (closest to the fuselage), and oriented such that the extension and retraction of the telescoping end section 24 does not interfere with the fuel flow system. In still another embodiment, the fuel tanks/bladders could be housed along the leading and/or training edges of root section 22, and oriented such that the extension and retraction of the telescoping section 24 does not interfere with the fuel flow system. In yet another embodiment, the fuel tanks/bladders could be housed in both the root section 22 and the telescoping end section 24.

One of ordinary skill in the art would realize that flight control linkages could be accommodated in the same fashion as the fuel tanks/bladders. Note also, that while FIGS. 2A and 2B depict a telescoping end section 24 affixed with conventional winglets, the invention may be employed with or without winglets.

The telescoping end section 24 can be extended or retracted in flight by a variety of actuating mechanisms, whether mechanical, electrical, hydraulic, optical, or some combination of the above. Weight, cost, complexity, redundancy, and operating missions will drive the decision as to what actuating system to employ.

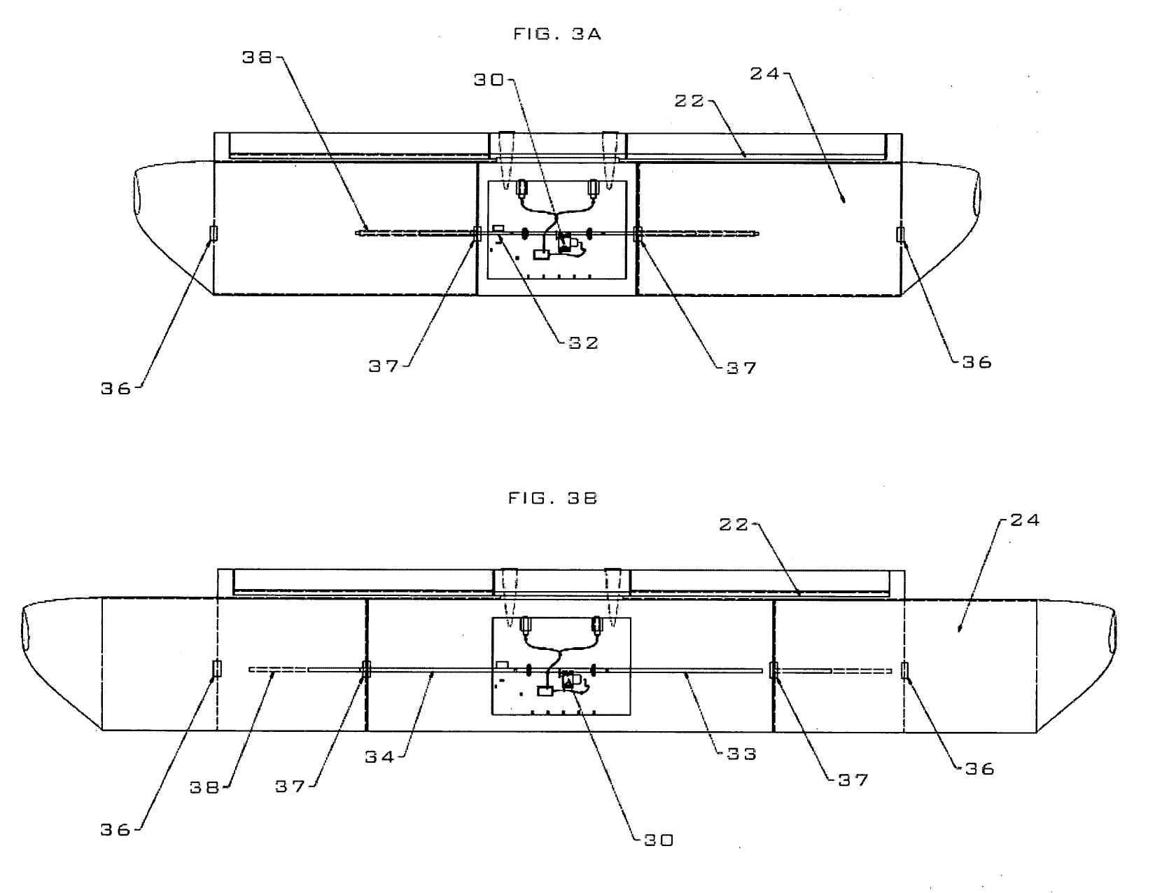

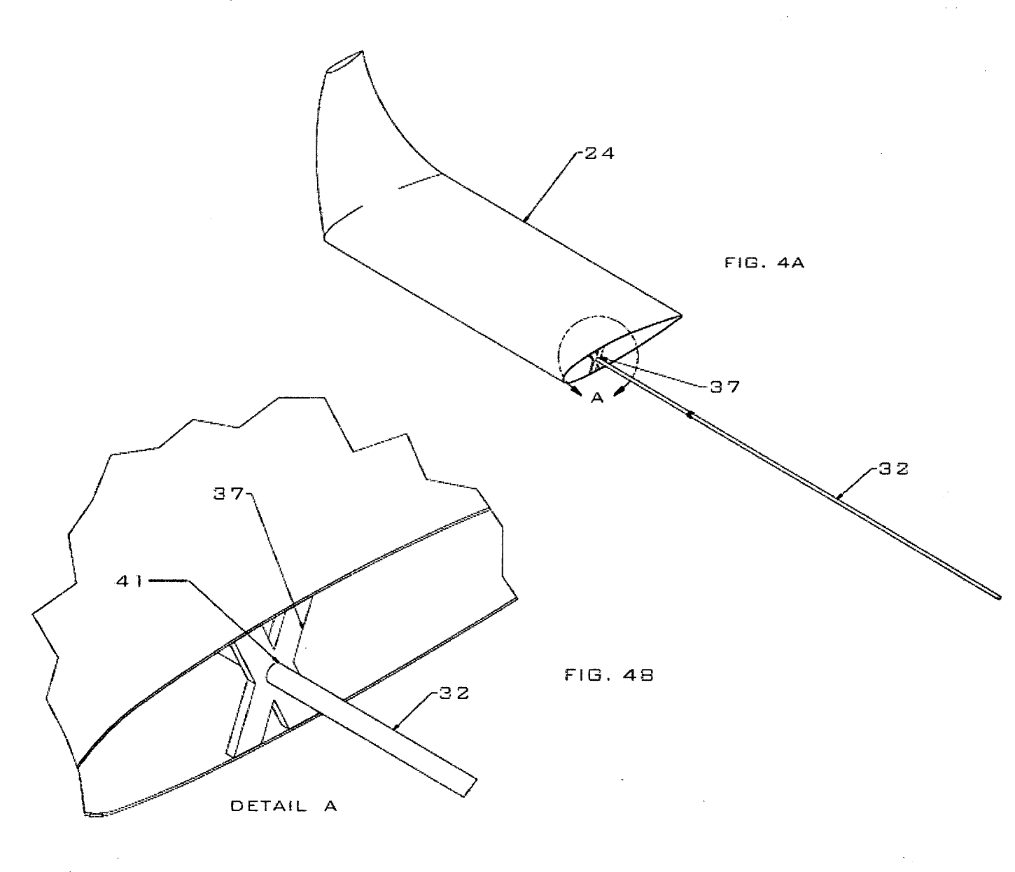

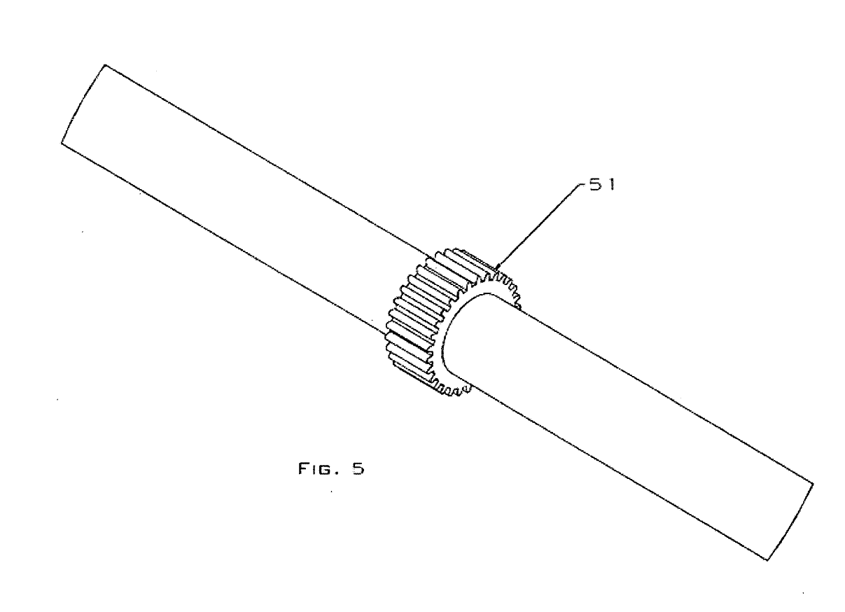

FIGS. 3A and 3B depict an exemplary mechanical means, comprising a jackscrew employed to slide the telescoping end section relative to the root section. FIG. 3A shows the telescoping end section 24 of the invention in a retracted configuration and in FIG. 3B in an extended configuration. One of ordinary skill in the art would realize that additional telescoping sections may be accommodated outboard of the telescoping end section 24. The invention can thus be used with multiple telescoping sections to achieve greater spanwise length.

In FIGS. 3A and 3B, a jackscrew gearbox and drive motor 30 communicates with rod 32. One portion 33 of the rod 32 is threaded in a right-hand direction, and the other portion 34 is threaded in a left-hand direction, so that operation of the jackscrew gearbox and drive motor 30 causes the telescoping end sections 24 to extend or retract in unison to prevent an asymmetrical fight condition. In addition, a manual hand crack or other suitable back-up means could be employed as a drive mechanism, should any of the other mechanical, electrical, optical or hydraulic means fail in flight.

In FIGS. 3A and 3B, the rod 32 connects to the telescoping end section 24 via a guide bracket/bearing 36 and a thrust bracket/bearing 37. FIGS. 4A and 4B illustrate an exemplary embodiment of the thrust bearing 37 in greater detail. Referring back to FIGS. 3A and 3B, note that there is shown a cylindrical jackscrew pocket 38 in the inner wing, through which the jackscrew rod 32 is positioned. Such a configuration would be advantageous if the fuel tanks/bladders where positioned in the telescoping end section 24. However, one of skill in the art would understand that the jackscrew pocket 38 could be a physically segregated area bounded by some defined components, or the pocket could merely be a void between two fuel tanks. In either case, there this a space for the rod 32 to operate therein.

FIGS. 3A and 3B position the guide bearing 36 at the distal end of the root section 22, and the thrust bearing 37 on the inner end of the telescoping end section 24, which may be the most stable configuration. However, the guide bearing 36 can be moved inward toward the fuselage, or even eliminated, depending on the desired length of travel of the telescoping end section 24. Also, the thrust bearing 37 can be moved outward toward the wing end, depending on the desired length of travel of the telescoping end section 24.

In FIGS. 4A and 4B, the thrust bearing 37 is in the shape of an “X” with a through hole 41 to accommodate the rod 32. Of course, one of skill in the art would understand that thrust bearing 37 (and guide bearing 36) may take any number of geometric forms, in order to achieve the function of translating the rotational motion of the rod 32 to spanwise movement of the telescoping end section 24.

FIG. 5 is a perspective view of the center gear section 51 of the exemplary jackscrew rod, which mates with the jackscrew gearbox and drive motor 30 of FIG. 3A to extend or retract the telescoping end section.

The advantages of the invention are numerous, and a general summary is presented below. Using relative scaled dimensions of the embodiments illustrated in FIGS. 3A and 3B, in the high-speed flight regimes, one can reduce the wing area and wetted area by 38.5%, and reduce the wing span by 33.3%, by fully retracting the telescoping end section 24.

In low-speed flight regimes, one can increase the wing area and wetted area by 62.5%, and increase the wingspan by 50%, by fully extending the telescoping end section 24.

Other general advantages include:
Increase/decrease wing area & wing span in flight
Increase/decrease wetted area in flight
Increase/decrease wing loading in flight
Decrease wing span for ground operation/maneuvering/storage
Eliminate the need for flaps/slats and associated complex mechanisms
Eliminate drag from associated flap/slat hardware such as hinges, bell cranks and tracks
Very simple actuation mechanism, completely internal
Increase cruise comfort in turbulence (increased wing loading-softer ride)
Expands wing performance envelope (V-max to V-stall)
Accomplishes all the above with no change to the center of gravity

The basic telescoping wing described above, and the associated flying characteristics can be enhanced in several ways, including employing different mechanisms to extend/retract the wing, and still further by incorporating the telescoping wing in other flight structures.

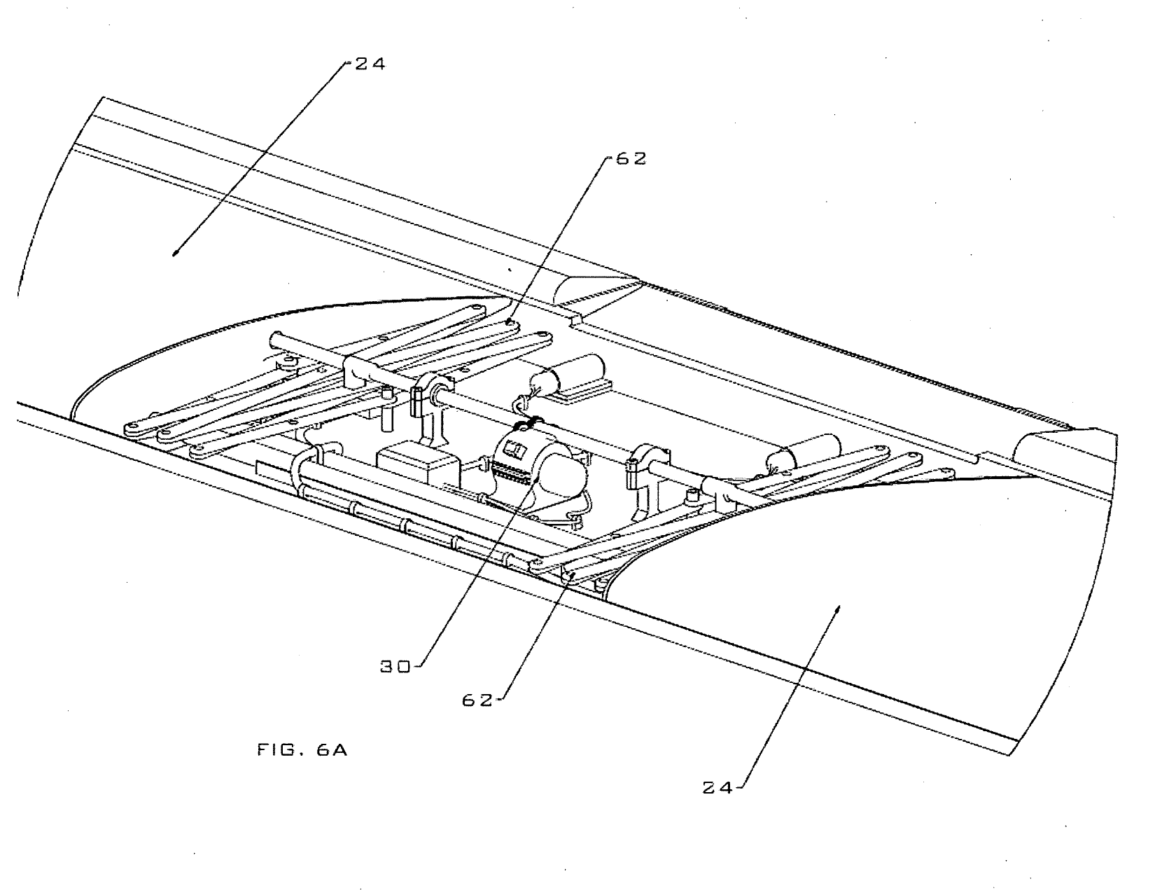

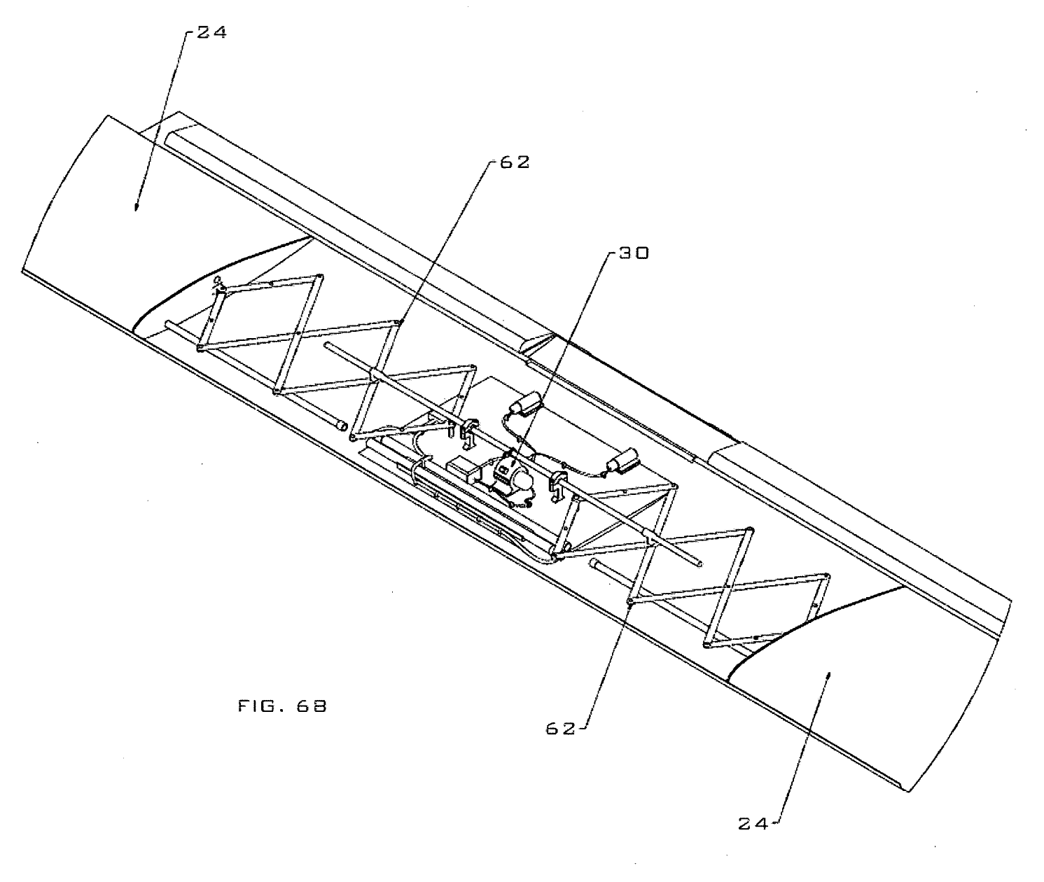

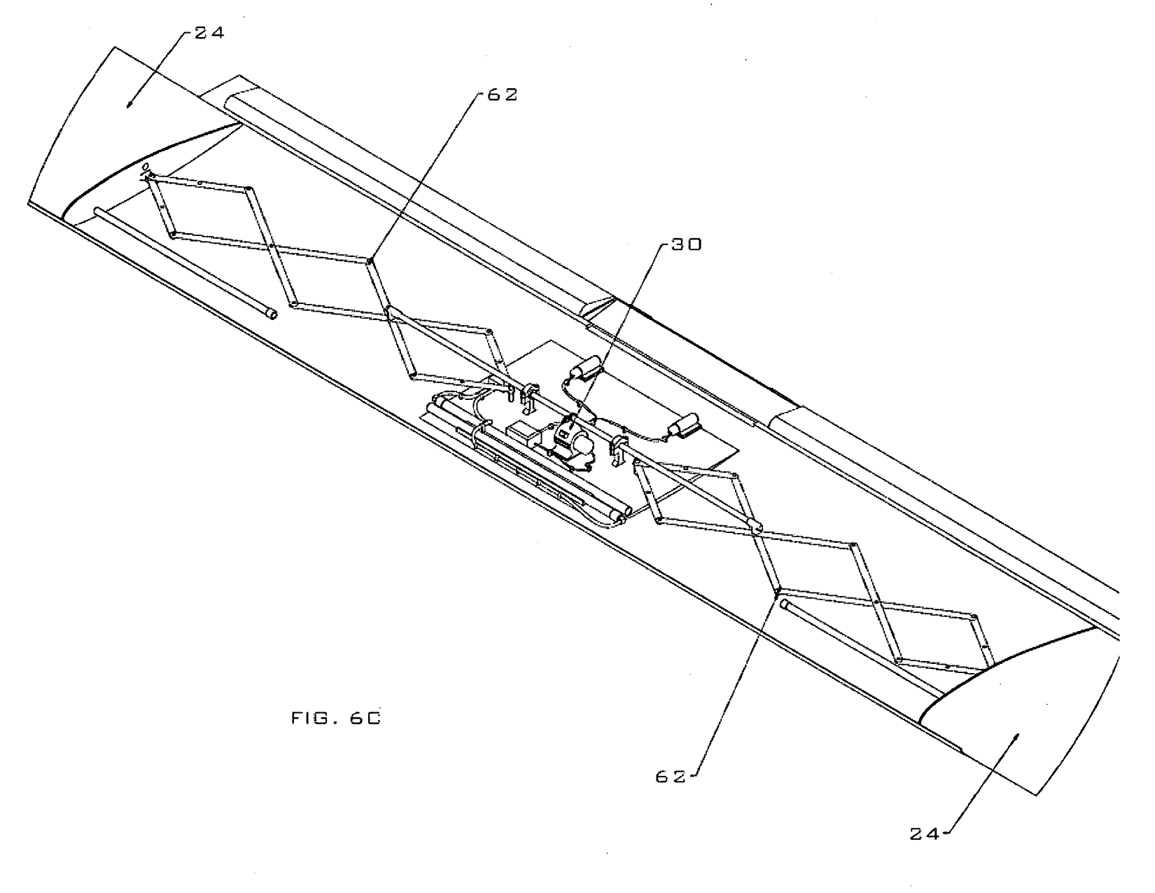

For example, with reference to FIGS. 6A-6C, an alternative method for extending and retracting the wing is illustrated. This exemplary embodiment incorporates a scissor gear mechanism 62 adapted for horizontal movement within the wing. The extension and retraction of the telescoping end sections 24 may be driven as in the earlier embodiments, such as with the jackscrew gearbox and drive motor 30, however in this embodiment they would communicate with scissor gear mechanism 62. FIG. 6A is a perspective view of the scissor gear embodiment in the fully retracted position; FIG. 6B is a perspective view of the scissor gear embodiment in the partially extended position; and FIG. 6C is a perspective view of the scissor gear embodiment in the fully extended position.

An additional synergistic advantage of the scissor gear mechanism 62 is that as the scissor gear mechanism 62 extends/retracts, the scissor gear mechanism 62 itself provides additional structural support (nodal support) along the upper and lower inner surfaces of the root section 22. This support would be accomplished by fashioning the scissor center bearings where the top of the bearing would be designed to contact the inside of the upper wing surface and the bottom of the center bearing would similarly contact the inner surface of the lower wing skin. This feature would be incorporated in some or all of the center bearings in the scissor jack. When extended, these equally spaced bearing caps would provide internal structural support to the fixed wing thereby increasing the load capability of the same wing without this internal support.

As in prior embodiments, the telescoping end section 24 can be extended or retracted in flight by a variety of actuating mechanisms, whether mechanical, electrical, hydraulic, optical, or some combination of the above. Weight, cost, complexity, redundancy, and operating missions will drive the decision as to what actuating system to employ.

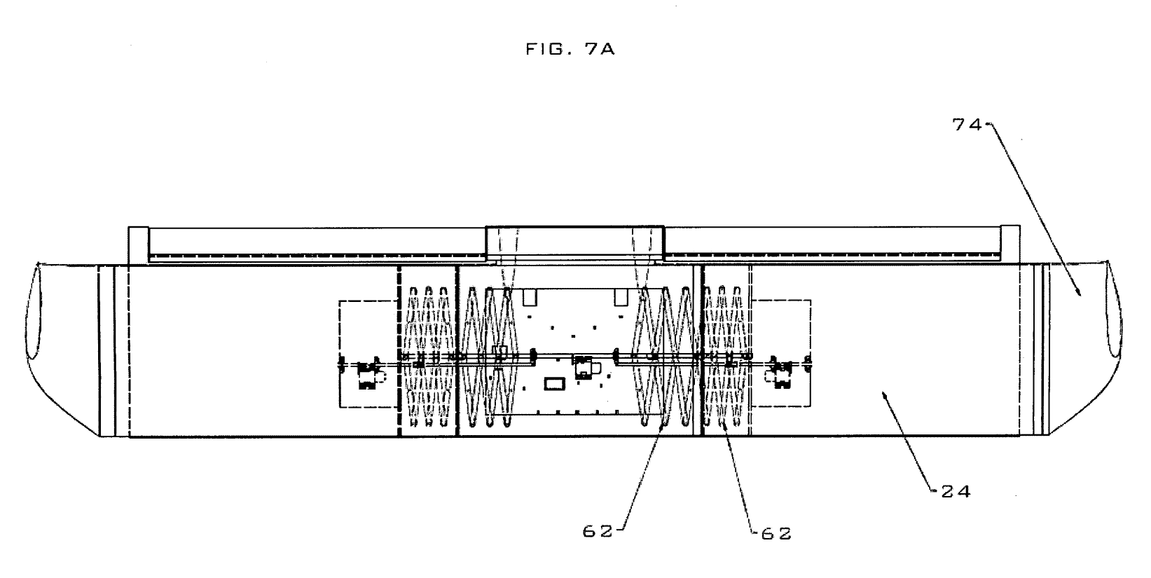

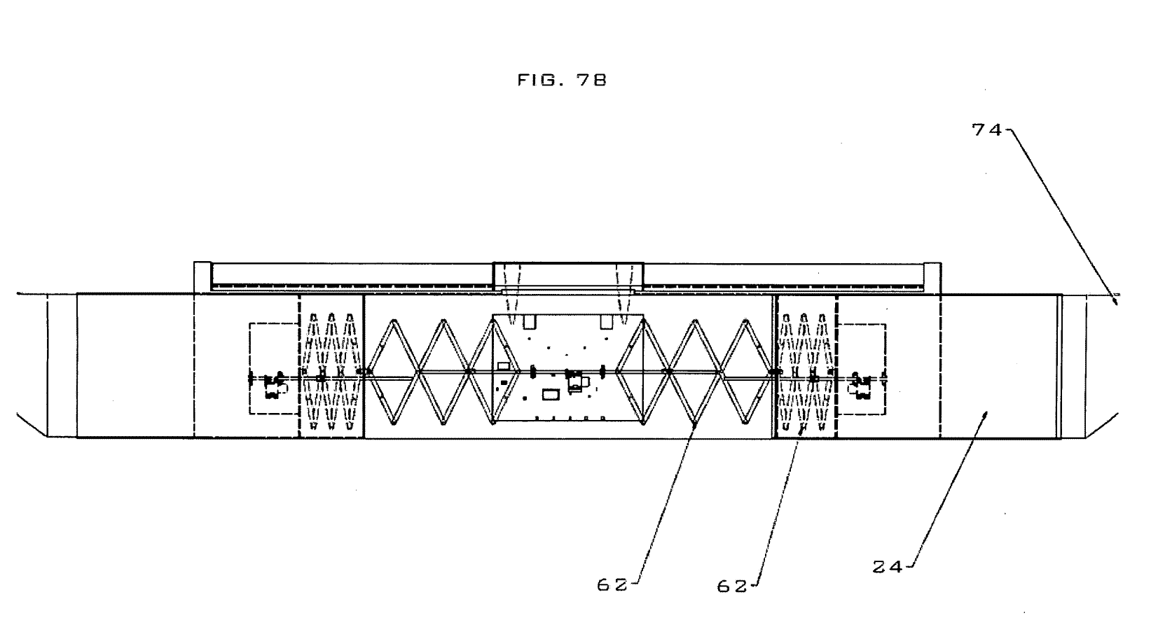

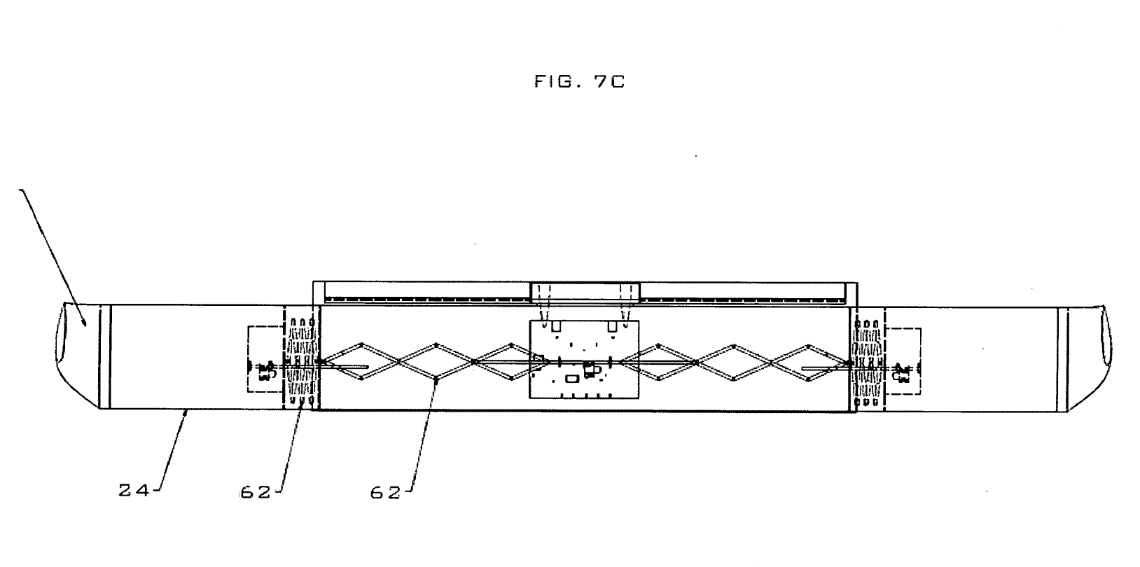

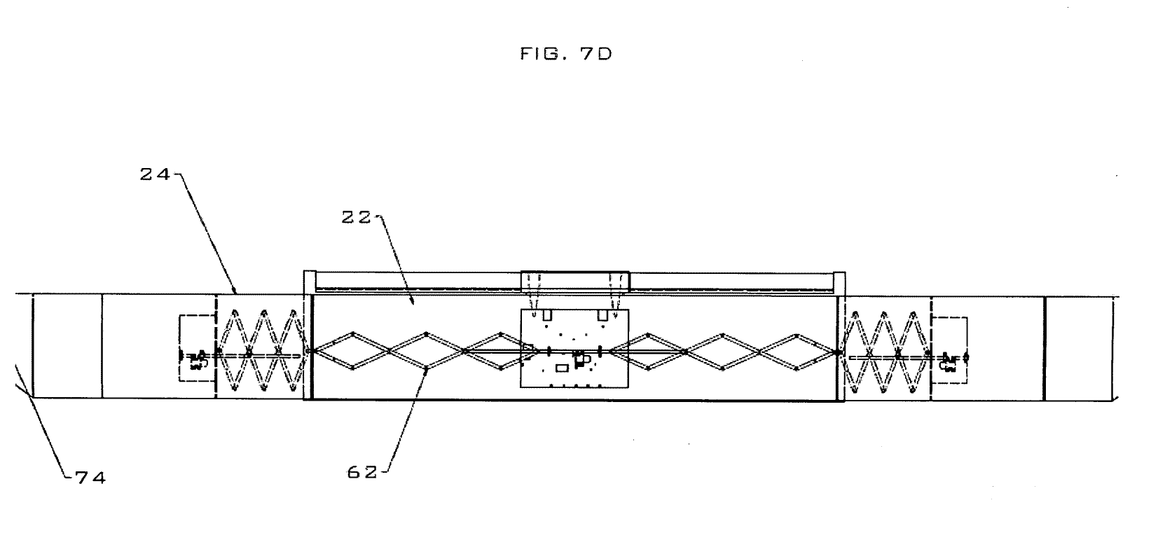

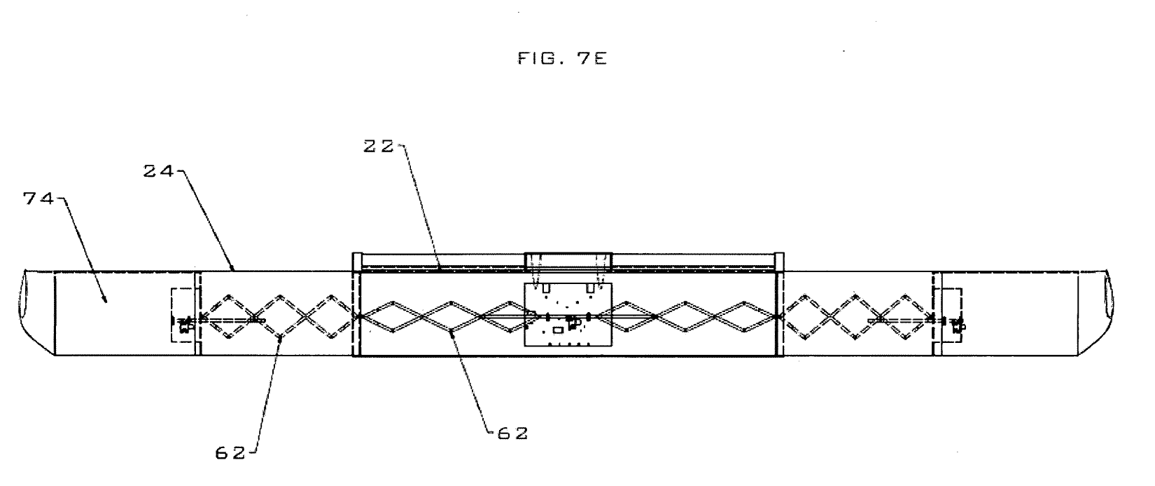

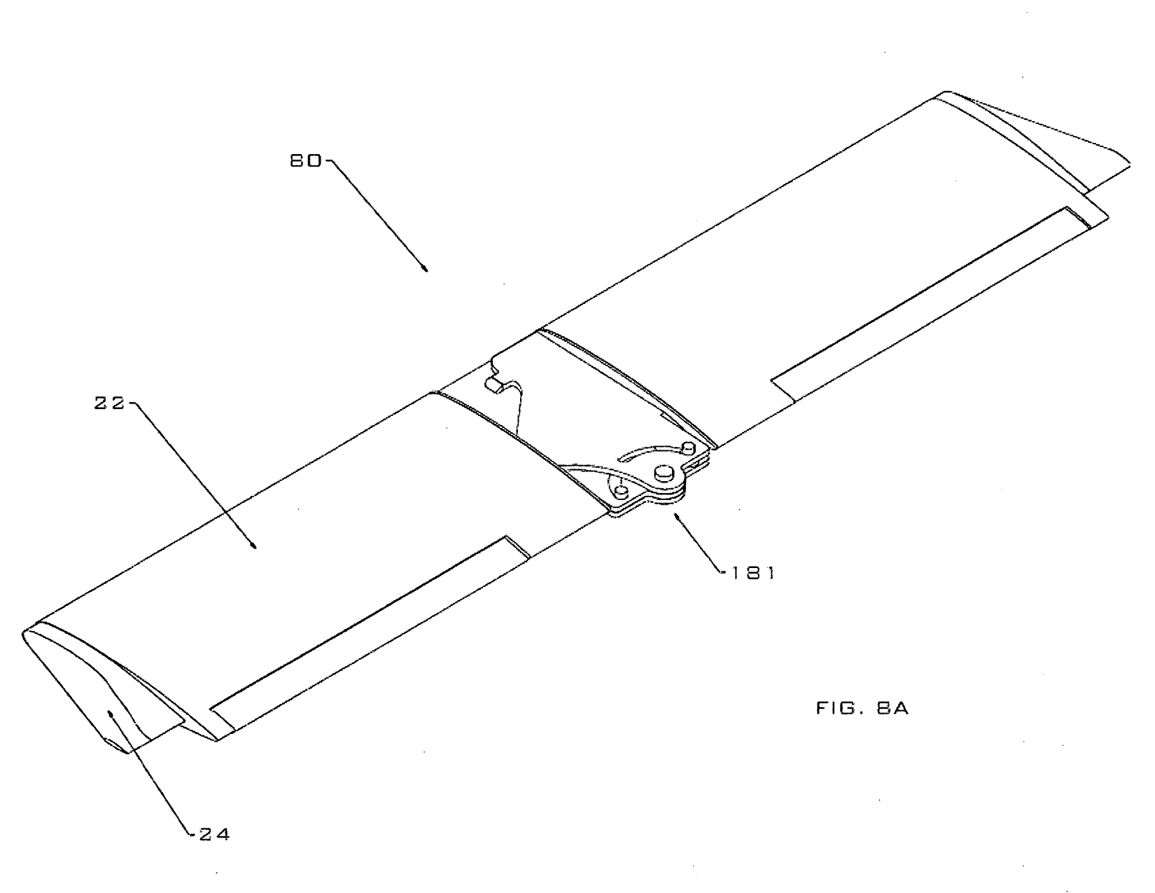

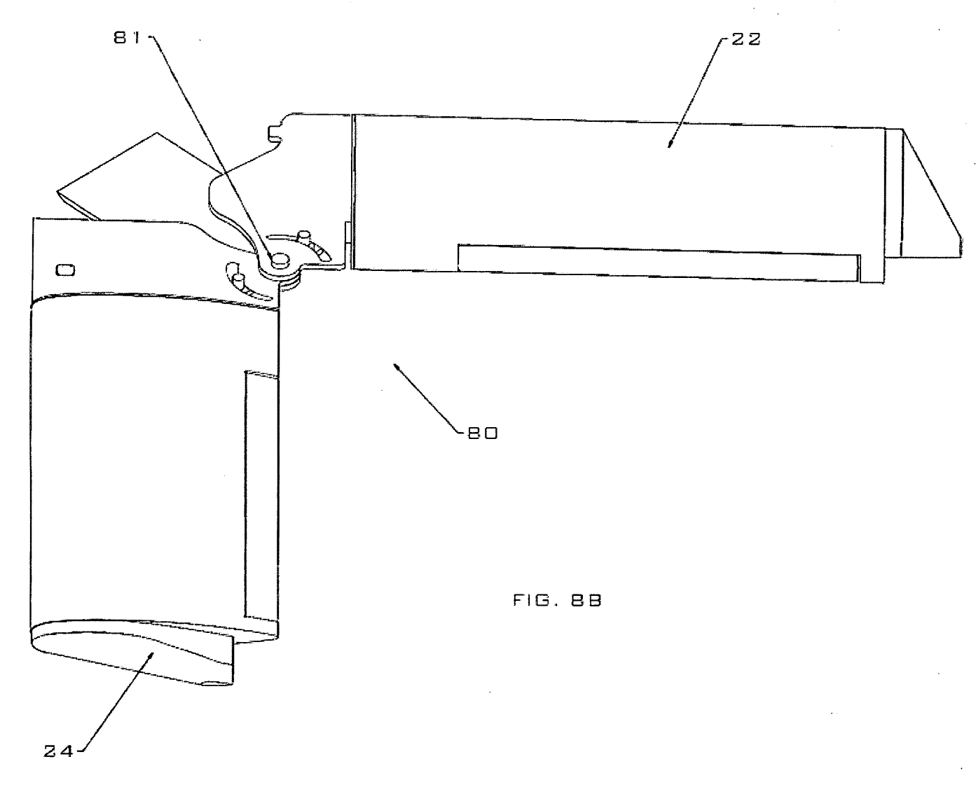

FIGS. 7A-7E depict a double-telescoping embodiment comprising an additional telescoping distal end section 74 that is slideable relative to each telescoping end section 24. In this embodiment, the additional telescoping distal section 74 can be extended or retracted in the same manner as the single-telescoping embodiments described above. For ease of reference, the scissor gear mechanism 62 is illustrated in FIGS. 7A-7E.

Further, the telescoping end section 24 and telescoping distal end section 74, for each side of the aircraft can be extended or retracted with one integrated mechanism, or separate extension/retraction mechanisms. Again, as described above, the telescoping distal end section 74 can be extended or retracted in flight by a variety of actuating mechanisms, whether mechanical, electrical, hydraulic, optical, or some combination of the above. Weight, cost, complexity, redundancy, and operating missions will drive the decision as to what actuating system to employ.

FIG. 7A through 7E show the double-telescoping embodiment in a series of consecutive views, with the telescoping end section 24 fully retracted, and the telescoping distal end section 74 fully retracted (FIG. 7A); the telescoping end section 24 partially extended, and the telescoping distal end section 74 fully retracted (FIG. 7B); the telescoping end section 24 fully extended, and the telescoping distal end section 74 fully retracted (FIG. 7C); the telescoping end section 24 fully extended, and the telescoping distal end section 74 partially extended (FIG. 7D); and the telescoping end section 24 fully extended, and the telescoping distal end section 74 fully extended.

One of ordinary skill in the art would understand that while a double-telescoping embodiment is shown, triple-telescoping and further multiple-telescoping embodiments would be carried out in the same manner. Of course, flight loads, mission requirements, space requirements, cost and complexity will dictate the optimum number of telescoping sections.

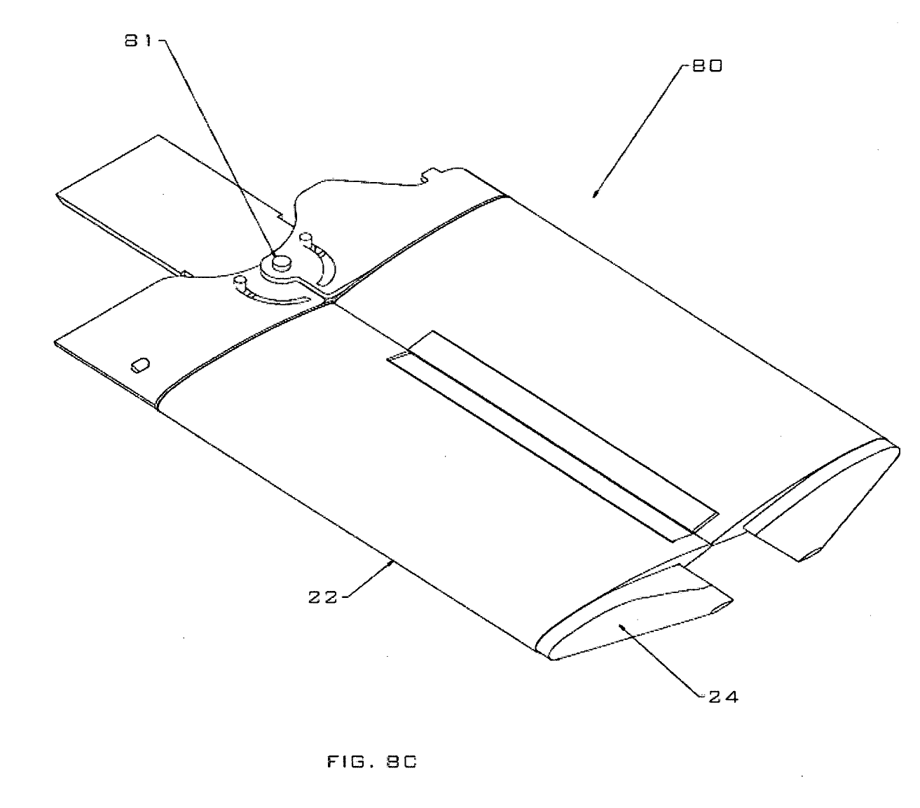

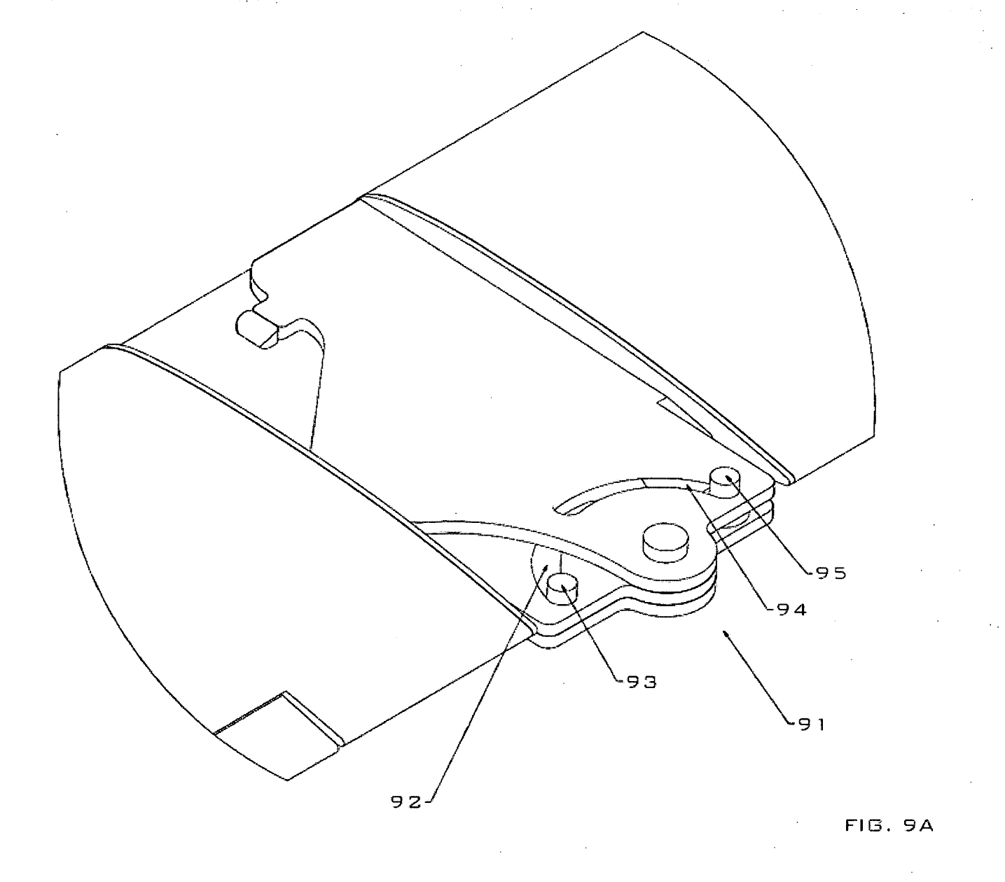

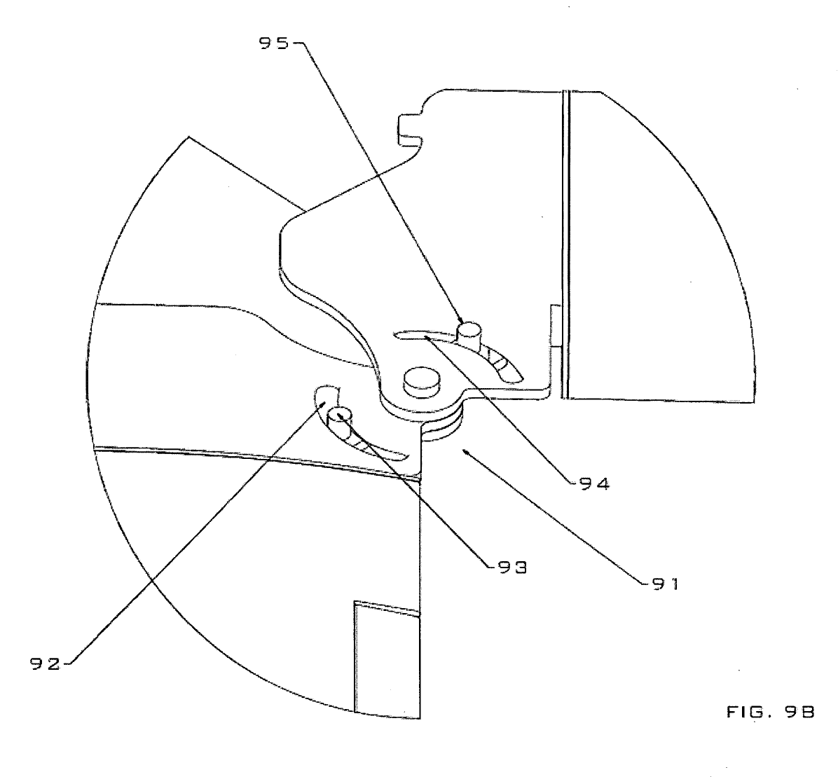

To further increase the flight performance envelope and expand mission capabilities, the telescoping wing described herein (either the single-telescoping or multiple-telescoping embodiments) can be incorporated into a sweeping wing configuration 80 as illustrated in FIGS. 8A, 8B and 8C. FIG. 8A shows the wing in a conventional configuration, FIG. 8B in a partially swept-back configuration, and FIG. 8C in a fully swept-back configuration. One of ordinary skill in the art would understand the telescoping/sweeping wing of the present invention could also sweep partially forward, or fully forward, depending on the flight vehicle and the mission envelope.

The sweep back mechanism 81 can be selected from a variety of conventional actuating mechanisms, whether mechanical, electrical, hydraulic, optical, or some combination of the above. Weight, cost, complexity, redundancy, and operating missions will drive the decision as to what actuating system to employ.

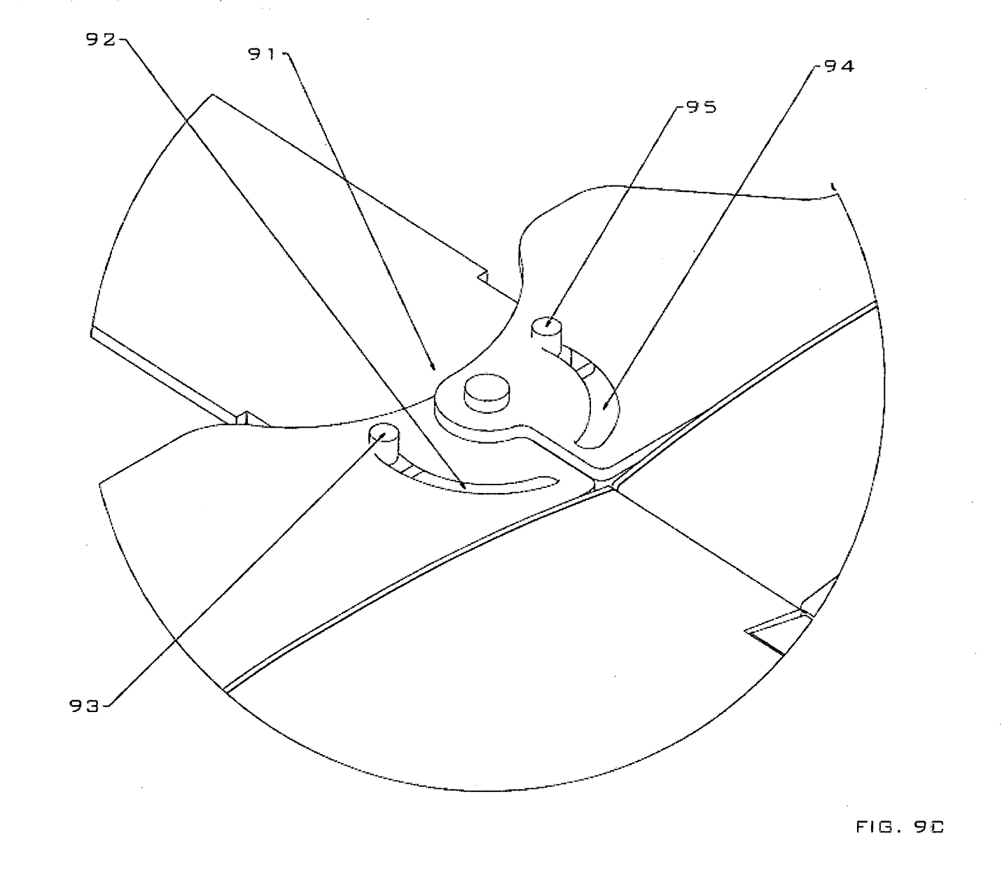

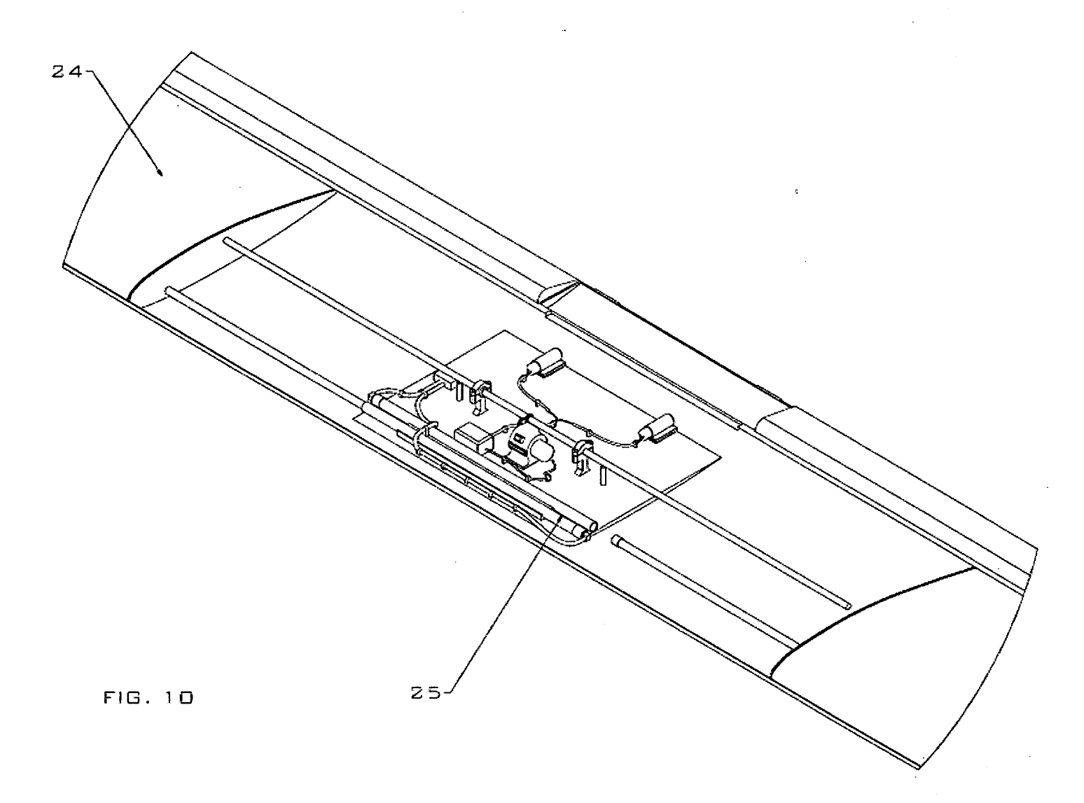

As shown in FIGS. 9A-9C, an exemplary sweep back mechanism guide means 91 includes semi-circular channels 92 and 94, and corresponding guide pins 93 and 95, acting as guides and support nodes as the wing sweeps backward and forward. One of skill in the art would understand that many different guide mechanisms and actuating mechanisms may be used to carry out the sweeping motion.

The telescoping wing ends 24, or telescoping distal wing ends 74, can be fully or partially extended during the sweeping evolution, and this will be dictated by designed flight loads, mission profile, and environmental conditions. For example, in a “high-g” maneuver, it would be advisable for load and performance reasons, to fully retract the telescoping end sections 24 and telescoping distal end sections 74 before sweeping the wings back.

In the swept-back configuration, the telescoping end sections 24, and/or the telescoping distal end sections 74, can be used as control surfaces for guiding the air vehicle.

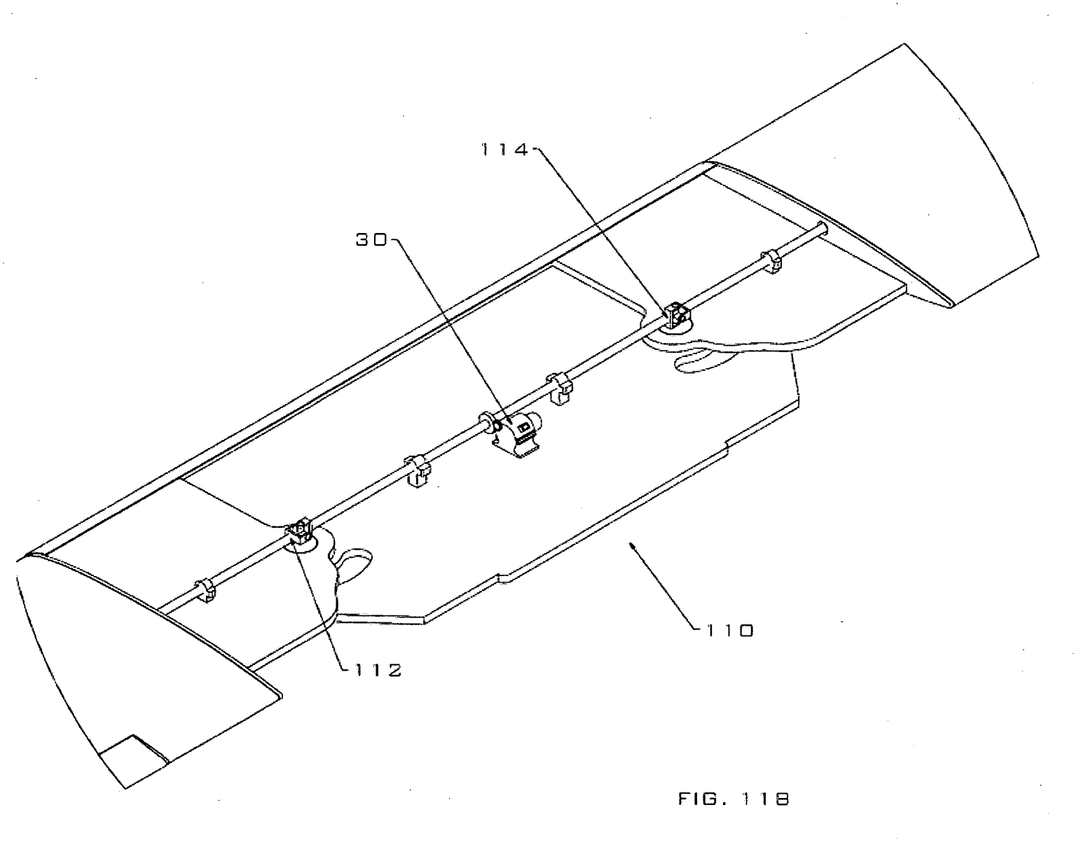

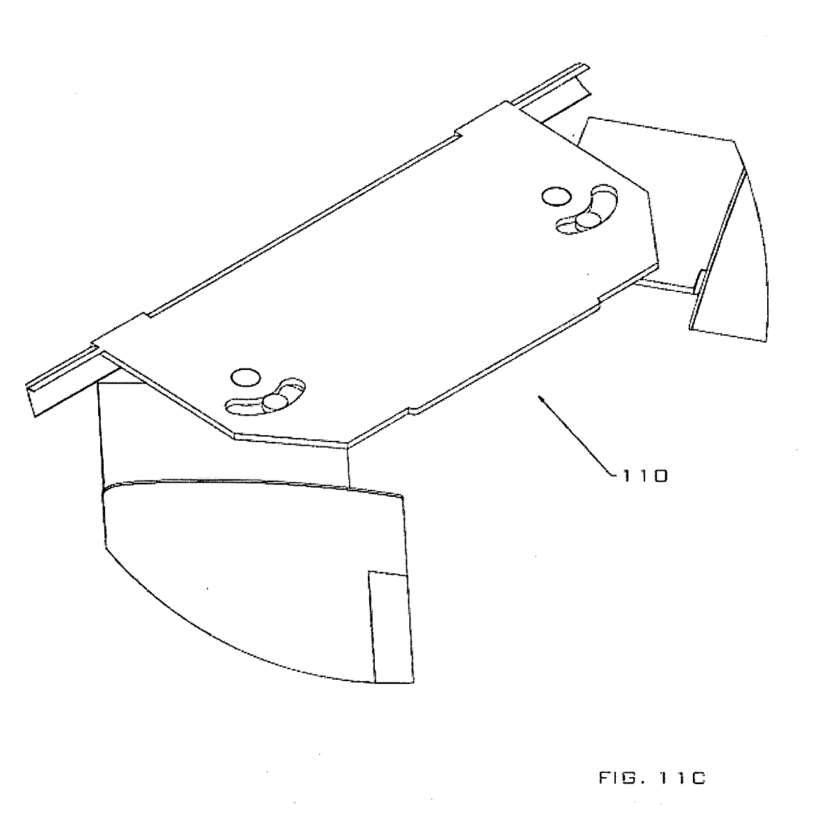

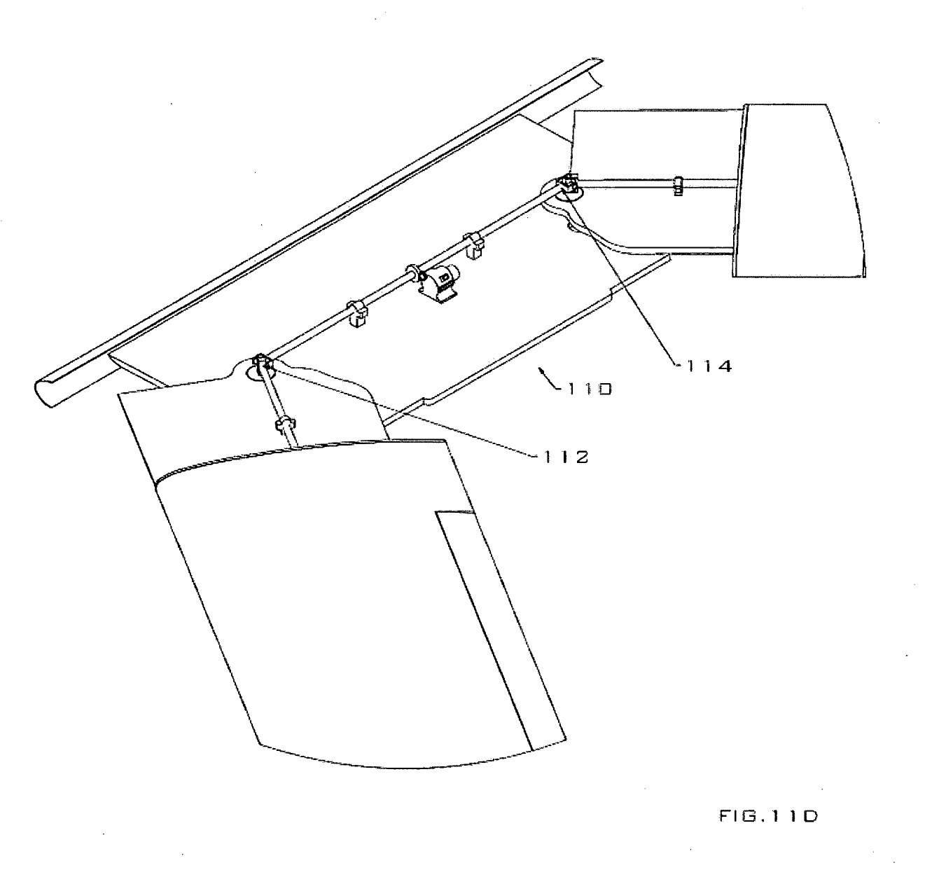

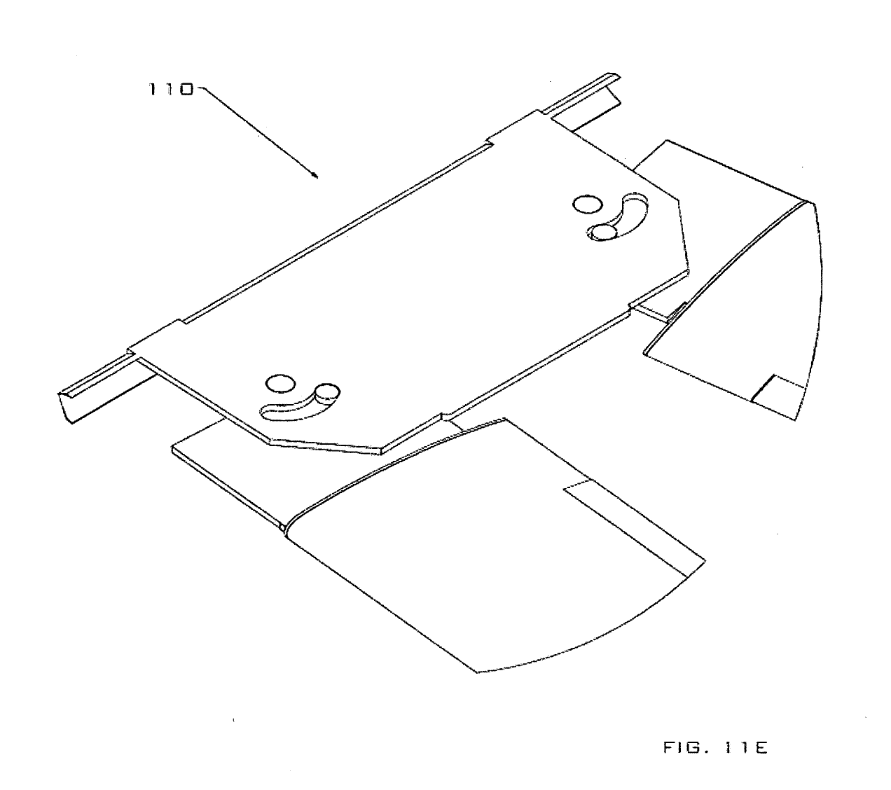

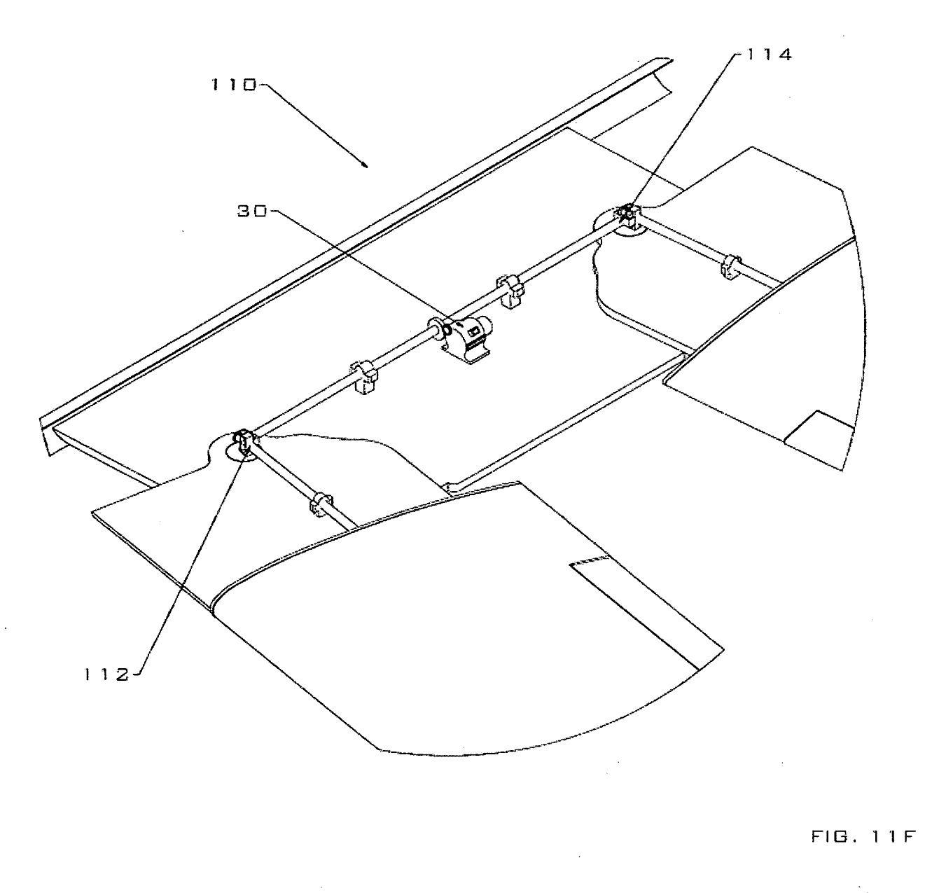

FIGS. 11A-11F illustrate an alternate guide means and wing sweep mechanism 110, employing universal joints 112 and 114 in communication with a single jackscrew gearbox and drive motor 30. In this embodiment, semi-circular channels 116 and 118, and corresponding guide pins 117 and 119, work in the same manner as those described in FIG. 9, and act as guides and support nodes as the wing sweeps backward and forward. FIGS. 11A, 11C and 11E illustrate a perspective view of this alternate guide means employing universal joints 112 and 114, with the wings in, respectively, a conventional spanwise configuration, a partially swept-back configuration, and a fully swept-back configuration. FIGS. 11B, 11D and 11F are the corresponding cut-away views illustrating the universal joints 112 and 114 in the various stages of wing sweep.

While the present invention has been described in detail with reference to the preferred embodiments thereof, it should be understood to those skilled in the art that various changes, substitutions and alterations can be made hereto without departing from the scope of the invention as defined by the appended claims.

What is claimed is:

1. An aircraft wing, comprising:
an airfoil shaped root section composed of a composite material; and
an airfoil shaped telescoping end section housed within the root section and composed of a composite material and in slideable connection with the root section to extend and retract during flight,
wherein the flight loads for the root section and the telescoping end section are carried predominately along external surfaces of the root section and telescoping end section, as the telescoping end section extends and retracts during flight.

2. An aircraft wing as claimed in claim 1, wherein the telescoping end section slides within the root section.

3. An aircraft wing as claimed in claim 1, wherein the telescoping end section slides over the root section.

4. An aircraft wing as claimed in claim 1, further comprising fuel storage means disposed in the telescoping end section.

5. An aircraft wing as claimed in claim 1, further comprising fuel storage means disposed in the root section.

6. An aircraft wing as claimed in claim 1, further comprising fuel storage means disposed in the telescoping end section and the root section.

7. An aircraft wing as claimed in claim 1, further comprising an airfoil shaped telescoping distal end section housed within the telescoping end section and composed of a composite material, and in slideable connection relative to the root section and the telescoping end section, to extend and retract during flight.

8. An aircraft wing as claimed in claim 7, further comprising means for sweeping the aircraft wing during flight.

9. An aircraft wing as claimed in claim 1, wherein the slideable connection comprises a scissor gear mechanism.

10. An aircraft wing, comprising:
an airfoil shaped root section composed of a composite material; and
an airfoil shaped telescoping end section housed within the root section and composed of a composite material and in slideable connection with the root section to extend and retract during flight,
wherein the flight loads for the root section and the telescoping end section are carried predominately along external surfaces of the root section and telescoping end section, as the telescoping end section extends and retracts during flight; and
means for sweeping the aircraft wing during flight.

11. An aircraft wing as claimed in claim 10, wherein the slideable connection comprises a scissor gear mechanism.

12. An aircraft wing as claimed in claim 10, further comprising an airfoil shaped telescoping distal end section housed within the telescoping end section and composed of a composite material, and in slideable connection relative to the root section and the telescoping end section, to extend and retract during flight.
